(19) United States
(12) Patent Application Publication
(10) Pub. No.: US 2019/0135427 A1
(43) Pub. Date: May 9, 2019

(54) TRI-ROTOR TAILSITTER AIRCRAFT

(71) Applicant: Bell Helicopter Textron Inc., Fort Worth, TX (US)

(72) Inventors: Daniel B. Robertson, Southlake, TX (US); Kirk L. Groninga, Keller, TX (US)

(21) Appl. No.: 15/808,856

(22) Filed: Nov. 9, 2017

(51) Int. Cl. B64C 29/02; B64D 27/24; B64C 3/56; B64C 11/28; B64C 7/02; B64C 39/02

(52) U.S. Cl. CPC B64C 29/02; B64D 27/24; B64C 3/56; B64C 11/28; B64C 7/02; B64C 2201/104; B64C 2201/021; B64C 2201/042; B64C 2201/088; B64C 2201/108; B64C 39/024

(57) ABSTRACT

In one embodiment, a tailsitter aircraft comprises a fuselage; a plurality of wings extending radially from the fuselage; a plurality of rotors coupled to the plurality of wings, wherein each rotor of the plurality of rotors is coupled to a particular wing of the plurality of wings, and wherein the plurality of rotors consists of three rotors; and at least one engine to power the plurality of rotors.

### TECHNICAL FIELD

This disclosure relates generally to aircraft design, and more particularly, though not exclusively, to a design for a tailsitter aircraft.

### BACKGROUND

Existing unmanned aerial vehicles (UAV) used for military and/or surveillance purposes are typically designed with long-range and/or high-endurance flight capabilities, while also being equipped with various types of equipment (e.g., surveillance, communication, and/or weaponry systems). A significant disadvantage of these UAVs, however, is the need for a substantial runway during takeoff and landing, as they do not have vertical takeoff and landing (VTOL) capabilities.

### SUMMARY

According to one aspect of the present disclosure, a tailsitter aircraft comprises a fuselage; a plurality of wings extending radially from the fuselage; a plurality of rotors coupled to the plurality of wings, wherein each rotor of the plurality of rotors is coupled to a particular wing of the plurality of wings, and wherein the plurality of rotors consists of three rotors; and at least one engine to power the plurality of rotors.

### BRIEF DESCRIPTION OF THE DRAWINGS

FIGS. 1A-D illustrate an example embodiment of a tri-rotor tailsitter aircraft.

FIGS. 2A-C illustrate an example embodiment of a propulsion system for a tri-rotor tailsitter aircraft.

FIG. 3 illustrates an alternative embodiment of a rotor drive system for a tri-rotor tailsitter aircraft.

FIG. 4 illustrates an example embodiment of a tri-rotor tailsitter aircraft with foldable wings and blades.

FIG. 5 illustrates a flowchart for an example operation of a tailsitter aircraft.

### DETAILED DESCRIPTION

The following disclosure describes various illustrative embodiments and examples for implementing the features and functionality of the present disclosure. While particular components, arrangements, and/or features are described below in connection with various example embodiments, these are merely examples used to simplify the present disclosure and are not intended to be limiting. It will of course be appreciated that in the development of any actual embodiment, numerous implementation-specific decisions must be made to achieve the developer's specific goals, including compliance with system, business, and/or legal constraints, which may vary from one implementation to another. Moreover, it will be appreciated that, while such a development effort might be complex and time-consuming, it would nevertheless be a routine undertaking for those of ordinary skill in the art having the benefit of this disclosure.

In the specification, reference may be made to the spatial relationships between various components and to the spatial orientation of various aspects of components as depicted in the attached drawings. However, as will be recognized by those skilled in the art after a complete reading of the present disclosure, the devices, components, members, apparatuses, etc. described herein may be positioned in any desired orientation. Thus, the use of terms such as “above,” “below,” “upper,” “lower,” or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction. Further, the present disclosure may repeat reference numerals and/or letters in the various examples. This repetition is for the purpose of simplicity and clarity and does not in itself dictate a relationship between the various embodiments and/or configurations discussed.

Example embodiments that may be used to implement the features and functionality of this disclosure will now be described with more particular reference to the attached FIGURES.

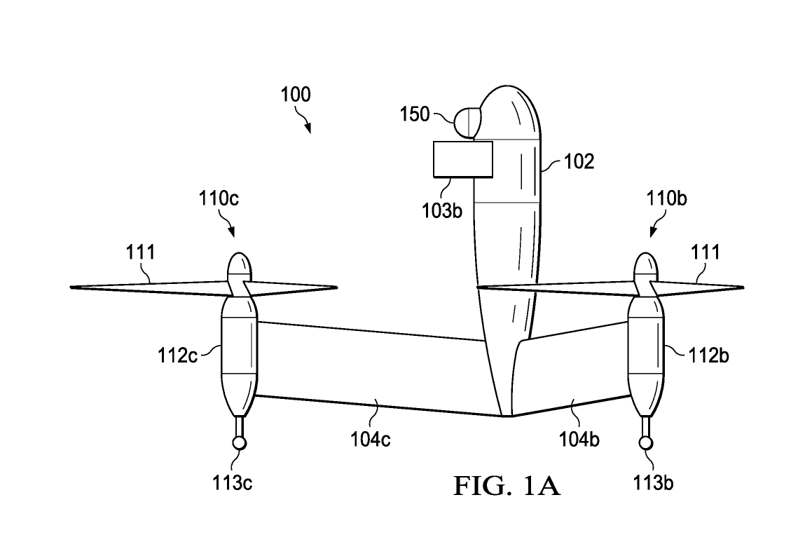

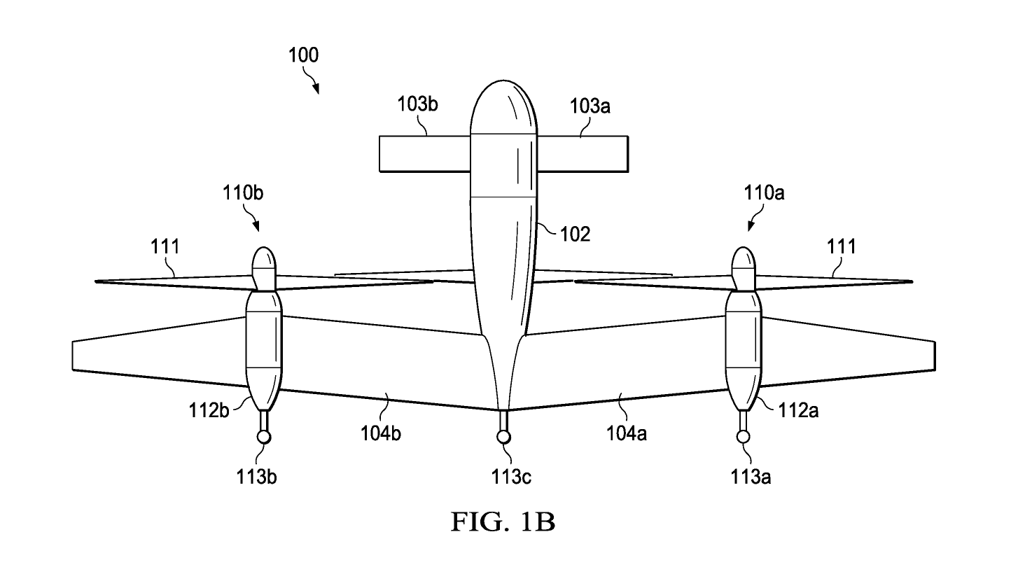

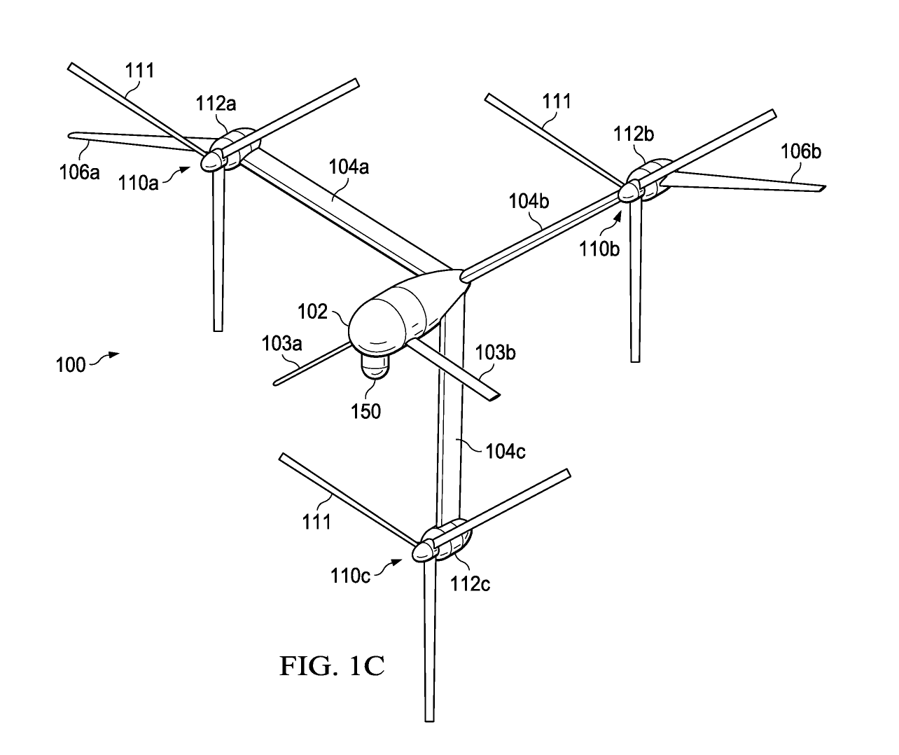

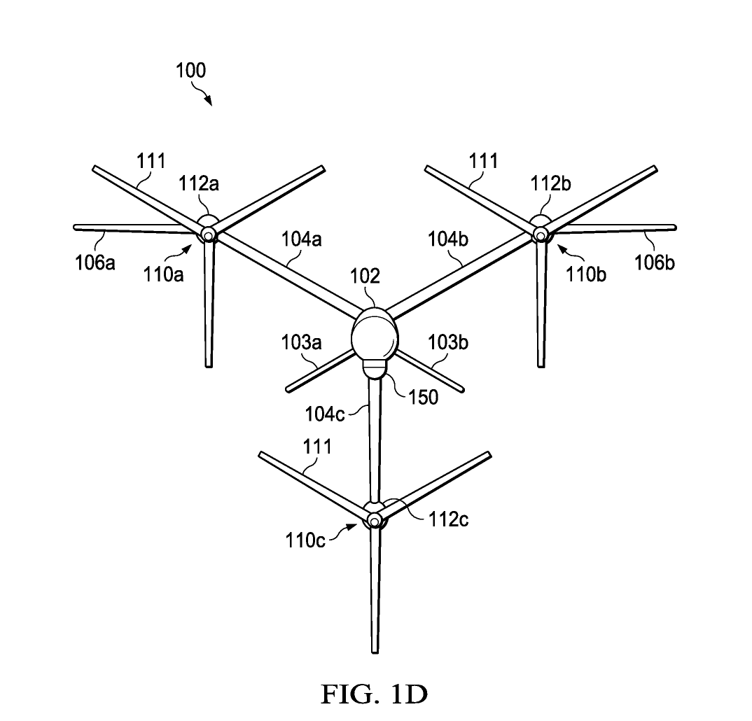

FIGS. 1A-D illustrate an example embodiment of a tri-rotor tailsitter aircraft 100. In some embodiments, tailsitter aircraft 100 may be an unmanned aerial vehicle (UAV) designed to provide the capabilities of an extended range multi-purpose (ERMP) UAV, while also providing vertical takeoff and landing (VTOL) capabilities. For example, an ERMP UAV (e.g., the General Atomics MQ-1C Gray Eagle) is an unmanned aircraft with long range and high endurance that is capable of high-altitude flight for extended periods of time. In some cases, for example, an ERMP UAV may be used for surveillance and/or attack purposes, and thus may be equipped with surveillance and imaging systems, communication systems, weapon and targeting systems, and so forth. A significant disadvantage of existing ERMP aircraft, however, is the need for a substantial runway during takeoff and landing, as they do not have vertical takeoff and landing (VTOL) capabilities. Thus, existing ERMP aircraft are not suitable in circumstances that lack an adequate runway for takeoff and landing, such as forward deployment by the military on an aircraft carrier. Moreover, UAVs that do provide VTOL capabilities, such as UAVs with helicopter designs, lack the requisite capabilities of ERMP aircraft used for surveillance and/or military purposes, such as long-range and high-endurance flight. For example, it is challenging to design a helicopter-style aircraft that achieves long-range and high-endurance flight, particularly due to the drag that results from the downwash of the rotor during forward flight, along with the lack of an airplane style wing.

Accordingly, in the illustrated embodiment, tri-rotor tailsitter aircraft 100 is designed to provide the capabilities of an extended range multi-purpose (ERMP) UAV, while also providing vertical takeoff and landing (VTOL) capabilities. Aircraft 100 uses a novel design to provide both ERMP aircraft capabilities and VTOL capabilities. In the illustrated embodiment, for example, aircraft 100 is a “tailsitter” aircraft, which is a type of aircraft that is capable of both vertical takeoff and landing (VTOL) and horizontal forward flight. For example, tailsitter aircraft 100 is implemented using rotors or “proprotors” 110a-c that can be used as both helicopter-style rotors and airplane-style propellers. Moreover, tailsitter aircraft 100 is a “tri-rotor” aircraft, meaning its primary flight capabilities are provided using three rotors or “proprotors” 110a-c. Accordingly, tailsitter aircraft 100 can take off and land vertically on its tail (thus using rotors 110a-c in helicopter mode), while tilting horizontally for forward flight (thus using rotors 110a-c in airplane mode). In this manner, tailsitter aircraft 100 provides helicopter-style VTOL capabilities, while also leveraging airplane-style forward flight in order to provide long-range and high-endurance flight capabilities. For example, the use of airplane-style wings and propellers during forward flight both improves flight endurance and eliminates the drag that results from rotor downwash in helicopter-mode, thus enabling long-range and high-endurance flight.

In the illustrated embodiment, for example, tailsitter aircraft 100 includes a body or fuselage 102, along with three wings 104a-c that extend radially from the fuselage 102. Moreover, in the illustrated embodiment, the wings 104a-c are positioned near the aft end of the fuselage 102, and are spaced apart approximately symmetrical. In other embodiments, however, the wings 104a-c may be configured using any suitable position, arrangement, spacing, or configuration. The end of each wing 104a-c is further coupled to a corresponding nacelle 112a-c, and each nacelle 112a-c houses a corresponding rotor 110a-c and associated components (e.g., power plant, engine, gearbox). The three rotors 110a-c each include a plurality of rotating rotor blades 111 to provide thrust for takeoff and cruise (e.g., three blades 111 per rotor 110a-c). For example, rotors 110a-c enable aircraft 100 to takeoff vertically on its tail, while subsequently enabling the aircraft to tilt horizontally to transition to forward flight. Moreover, two of the wings 104a,b include wing extensions 106a,b positioned outboard of the respective nacelles 112a,b. For example, when tailsitter aircraft 100 is tilted horizontally during forward flight, two of the wings 104a,b extend laterally at an upwards angle relative to the fuselage 102, while the third wing 104c extends vertically directly below the fuselage 102 (e.g., as shown in FIGS. 1C-D). Accordingly, the wing extensions 106a,b are only incorporated on the two wings 104a,b that extend laterally during forward flight. Moreover, the wing extensions 106a,b are positioned at an angle relative to the associated wings 104a,b , thus resulting in a horizontal orientation for the wing extensions 106a,b during forward flight. In this manner, the wing extensions 106a,b can provide additional lift and/or stability in forward flight. Canards 103a-b are also positioned on the fuselage 102 forward of the wings 104a-c in order to improve control and/or stability. Landing gear 113a-c is incorporated at the aft end of each of the nacelles 112a-c, such that the landing gear 113a-c is below aircraft 100 when the aircraft is oriented vertically on its tail during takeoff and landing. In this manner, landing gear 113a-c creates a very stable base that enables aircraft 100 to take off and land in areas that are unimproved, uneven, sloped, and so forth.

Moreover, in some embodiments, rotors 110a-c may be implemented with the control capabilities of typical helicopter rotors, such as fully flapping rotors with pitch, yaw, and roll control. For example, the pitch of each rotor blade 111 can be adjusted in order to selectively control direction, thrust, and lift for tailsitter aircraft 100. In this manner, aircraft 100 is provided with improved control and stability and can safely perform its various maneuvers, such as takeoff, landing, transition and recovery to and from forward flight, and so forth. For example, during takeoff and landing, one or more rotors 110 can be slightly tilted to compensate for the yawing moment that results during hover. As another example, tailsitter aircraft 100 may transition from takeoff to forward flight by adjusting the collective pitch of the blades 111 of two of the rotors 110a,b, thus causing tailsitter aircraft 100 to gradually tilt from a vertical flight orientation to a horizontal (forward) flight orientation (e.g., resembling a parabolic flight trajectory). As another example, tailsitter aircraft 100 may perform a recovery maneuver to transition back from forward flight to hover for landing. For example, in some embodiments, tailsitter aircraft 100 may perform a stall maneuver to transition from a horizontal orientation for forward flight into a vertical orientation for hover, and may then gradually decrease its altitude while hovering in order to land safely and controllably.

In one example embodiment, aircraft 100 may have an overall length of approximately 15 feet (e.g., between the forward end of the fuselage 102 and the aft end of the landing gear 113a-c ), an overall width of approximately 32 feet (e.g., between the outboard ends of the two wing extensions 106a,b), a rotor 110 diameter of approximately 16 feet (e.g., 8 feet per rotor blade 111), and spacing of approximately 11.5 feet between the fuselage 102 and each rotor hub 110a-c. In other embodiments, however, aircraft 100 may be implemented using any suitable or desired dimensions. For example, implementing aircraft 100 with the described dimensions would qualify it as a Group III UAV under the U.S. Department of Defense UAV classifications, while in other embodiments, the dimensions and/or capabilities of aircraft 100 could be scaled to qualify it as a Group IV or V classification.

In this manner, tri-rotor tailsitter aircraft 100 can provide the capabilities of an extended range multi-purpose (ERMP) UAV, while also providing vertical takeoff and landing (VTOL) capabilities. In some embodiments, for example, aircraft 100 may be a UAV designed to operate autonomously and capable of dynamically re-tasking. Moreover, in some embodiments, aircraft 100 may be capable of long range missions of approximately 1000 nautical miles, at a cruise speed of approximately 120 knots, and while carrying a payload of approximately 250 pounds. Accordingly, aircraft 100 can be particularly suitable for surveillance and/or attack purposes, as it can be equipped with surveillance and imaging systems (e.g., electro-optical/infrared (EO/IR)), communication systems (e.g., communications relay, tactical common data link (TCDL), SATCOM), weapon and targeting systems (e.g., weapons payloads, laser designator (LD) targeting), and so forth. In the illustrated embodiment, for example, aircraft 100 includes a payload 150 positioned under the nose, which could be used to house a variety of equipment depending on the desired capabilities. Moreover, since aircraft 100 can be unmanned, VTOL capabilities can be implemented using a tailsitter design instead of a tiltrotor or tiltwing design, thus eliminating the additional components and functionality required for tiltrotor and tiltwing designs. The VTOL capabilities of aircraft 100 enable takeoff and landing in relatively small areas (e.g., 50 feet in diameter) and/or areas with hazardous conditions (e.g., unimproved, uneven, and/or sloped surfaces). In this manner, aircraft 100 is particularly suitable for forward deployment by the military (e.g., on an aircraft carrier), thus enhancing the ability of a forward operating military unit to control the battlefield without dependence on remotely deployed and operated UAVs.

Additional embodiments and implementations are described below with reference to the remaining FIGURES. It should be appreciated that aircraft 100 of FIG. 1 may be implemented using any aspects of the embodiments illustrated and/or described in connection with the remaining FIGURES. Moreover, it should also be appreciated that aircraft 100 of FIG. 1 is merely illustrative of a wide variety of possible aircraft configurations that can be implemented based on the teachings of this disclosure. In other embodiments, for example, aircraft 100 could be implemented using different numbers, arrangements, sizes, and/or dimensions of components (e.g., wings, rotors, nacelles, canards), and as either an unmanned or manned (e.g., piloted) aircraft, among other possible variations.

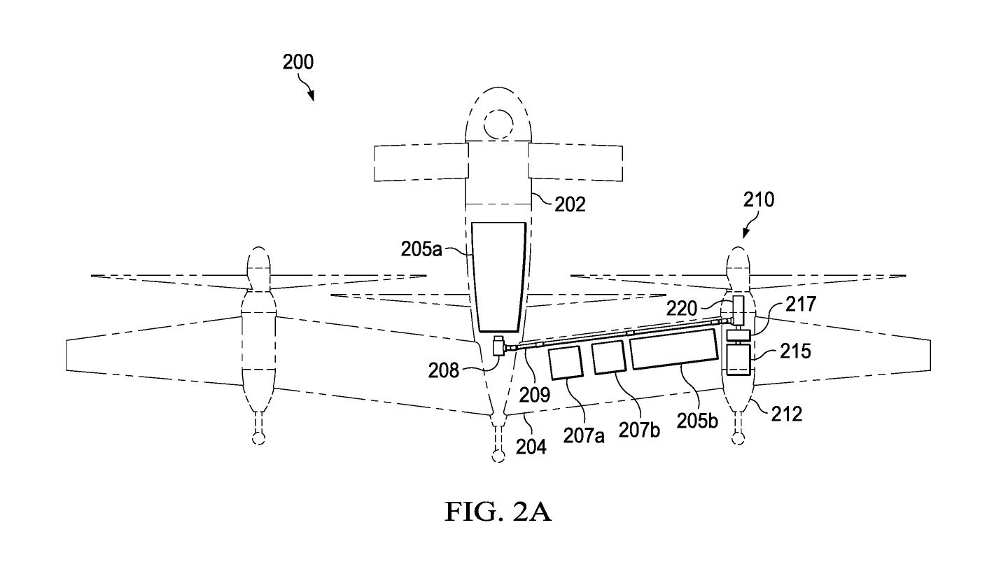

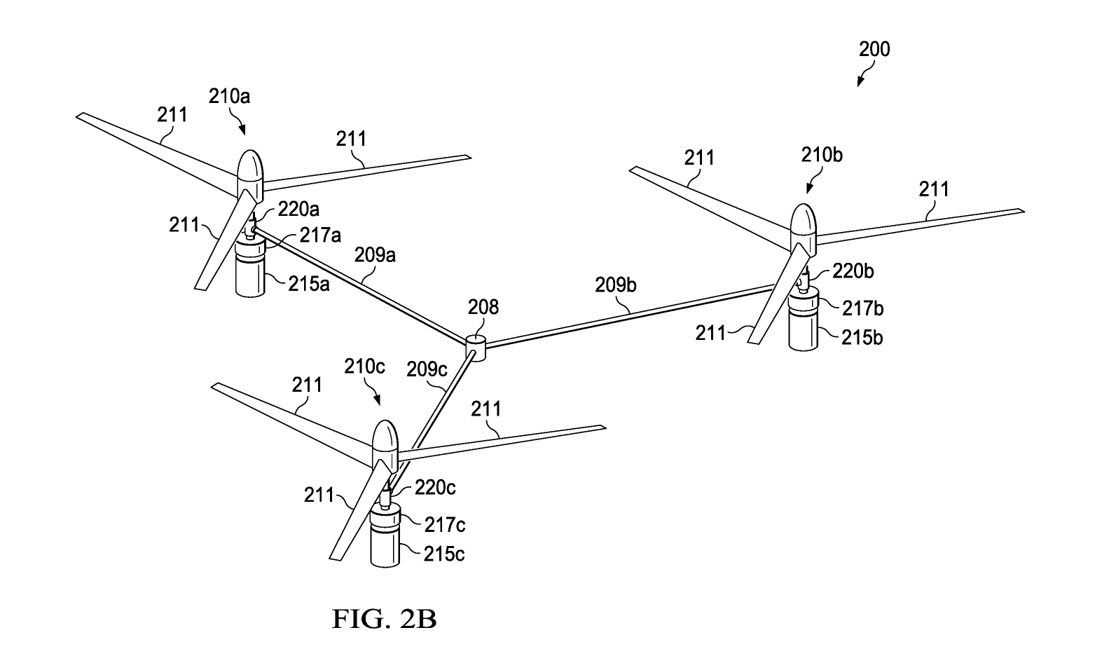

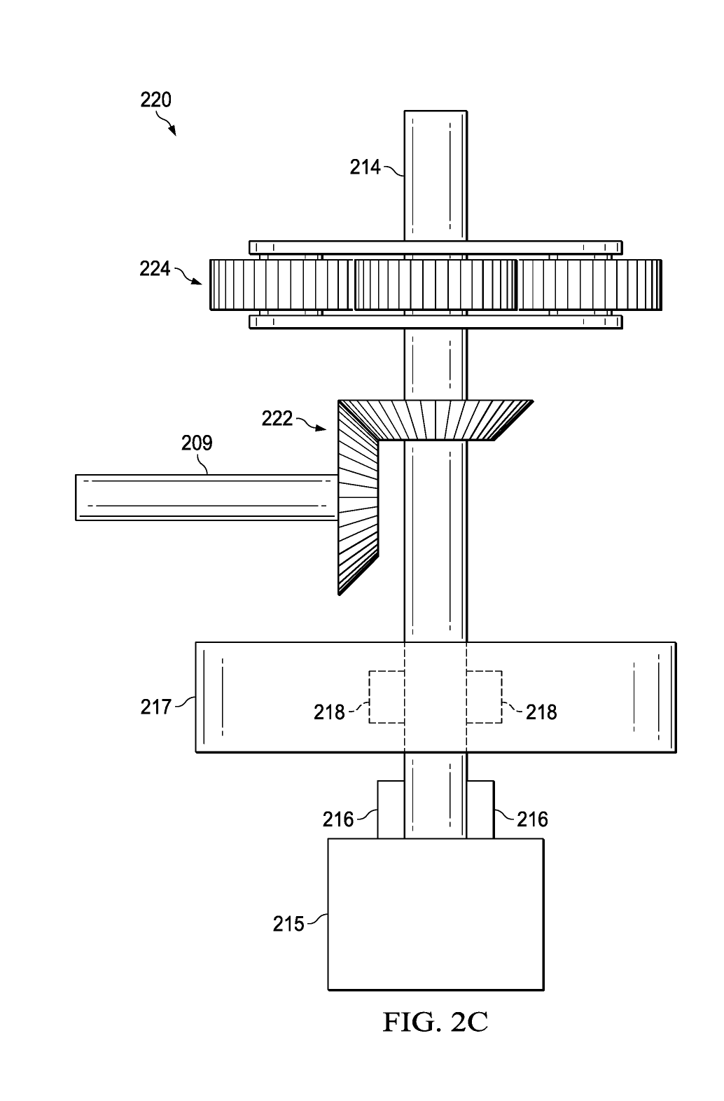

FIGS. 2A-C illustrate an example embodiment of a propulsion system 200 for a tri-rotor tailsitter aircraft. In some embodiments, for example, propulsion system 200 may be used to implement the flight capabilities of tri-rotor tailsitter aircraft 100 of FIG. 1.

FIG. 2A illustrates the overall architecture of propulsion system 200. In the illustrated embodiment, propulsion system 200 is designed for a tailsitter aircraft with three wings 204 and three rotors 210. For simplicity, however, the components of propulsion system 200 are only illustrated for a single wing 204 and rotor 210, although the remaining wings and rotors may include similar components.

In the illustrated embodiment of propulsion system 200, the fuselage 202 includes a primary fuel tank 205a, and each wing 204 includes a secondary fuel tank 205b along with multiple batteries 207a,b. Each wing 204 also includes a nacelle 212 that houses a rotor 210 and associated components, including a diesel engine 215, electric motor 217, and rotor gearbox 220. Each rotor 210 is powered by its associated diesel engine 215, which operates using fuel from fuel tanks 205a,b. In some embodiments, for example, the respective diesel engines 215 may share fuel from the primary fuel tank 205a located in the fuselage 202, and each diesel engine 215 may also use fuel from its own secondary fuel tank 205b located in its associated wing 204. Moreover, although the illustrated embodiment uses diesel engines 215, other embodiments may use any type of engine(s).

Moreover, during vertical takeoff and landing (VTOL), electric motors 217 may be used to augment the power provided to the rotors 210 by the respective diesel engines 215. In this manner, propulsion system 200 can be implemented using diesel engines 215 tailored with the minimum amount of power needed for forward flight, thus minimizing engine and fuel weight. For example, the rotors 210 require more power for hover during takeoff and landing than for forward flight. Moreover, although the rotors 210 could be powered using diesel engines that are capable of generating enough power for hover, that requires the use of heavier diesel engines whose full power is unnecessary for forward flight and would only be leveraged during hover. Accordingly, in the illustrated embodiment, propulsion system 200 is implemented using lighter weight diesel engines 215 with the minimum of amount of power required for forward flight, along with electric motors 217 that provide the additional power required for hover during takeoff and landing. The electric motors 217 are powered by batteries 207 located in the respective wings 204, and the batteries 207 can be recharged during forward flight or cruise. For example, in some embodiments, the electric motors 217 only provide power to the rotors 210 during takeoff and landing. Accordingly, when the aircraft transitions from takeoff to forward flight, the electric motors 217 stop providing power to the rotors 210 and instead serve as generators to recharge their associated batteries 207, thus allowing the batteries 207 to once again power the electric motors 217 during landing. In this manner, propulsion system 200 minimizes engine and fuel weight, and thus increases the maximum mission range.

Finally, as described further below in connection with FIGS. 2B, an interconnect drive shaft 209 is used to couple the gearbox 220 of each rotor 210 to a center gearbox 208 located in the fuselage 202, thus allowing engine power to be shared among the rotors 210 and providing redundancy in the event of an engine failure.

FIG. 2B illustrates a more detailed view of the drive system for the rotors of propulsion system 200. In particular, propulsion system 200 includes three rotors 210a-c, and each rotor 210 includes a plurality of rotor blades 211 capable of rotating to provide thrust for takeoff and cruise. Although the illustrated embodiment includes three blades 211 per rotor 210a-c, other embodiments may be implemented using any number of blades. Moreover, as described above in connection with FIG. 2A, each rotor 210a-c includes an associated diesel engine 215, electric motor 217, and rotor gearbox 220. The diesel engines 215a-c and electric motors 217a-c generate power, which causes the rotor gearboxes 220a-c to drive torque to the rotors 210a-c. An example implementation of a rotor gearbox 220a-c is further illustrated and described in connection with FIG. 2C below.

Each rotor gearbox 220a-c is further coupled to a center gearbox 208 via an interconnect drive shaft link 209a-c, which allows the rotors 210a-c to share power from their respective diesel engines 215a-c and electric motors 217a-c, thus providing redundancy in the event of an engine or motor failure. For example, if a diesel engine 215a powering a particular rotor 210a fails, that rotor 210a can still be powered by the diesel engines 215b,c associated with the remaining rotors 210a-c. For example, power from the engines 215b,c of the remaining rotors 210a-c is driven from their associated gearboxes 220b,c through interconnect drive shaft links 209b,c to the center gearbox 208, and then from the center gearbox 208 through interconnect drive shaft link 209a to the gearbox 220a of the rotor 210a whose engine failed. This design similarly enables the rotors 210a-c to share power from their respective electric motors 217a-c, thus providing redundancy in the event of a motor failure.

FIG. 2C illustrates an example embodiment of a rotor gearbox 220 for propulsion system 200. In the illustrated embodiment, rotor gearbox 220 includes a mast 214 driven by a diesel engine 215 and/or electric motor 217. For example, as described above in connection with FIG. 2A, diesel engine 215 may be used to power an associated rotor 210 (shown in FIGS. 2A-B) during forward flight, while electric motor 217 may be used to augment the power of diesel engine 215 during hover for takeoff and landing. Accordingly, in the illustrated embodiment of gearbox 220, the lower portion of mast 214 interfaces with diesel engine 215 and electric motor 217, while the upper portion of mast 214 interfaces with the associated rotor 210 (not shown in FIG. 2C). In this manner, power from diesel engine 215 and/or electric motor 217 can be used to generate torque that causes mast 214 to rotate, and the rotation of mast 214 similarly causes the associated rotor 210 (shown in FIGS. 2A-B) to rotate. In order to achieve the appropriate rotor speed, however, gearbox 220 further includes a planetary gear set 224 to reduce the rotational speed of the mast 214, thus achieving the appropriate rotations-per-minute (RPM) or tip speed for the blades of the rotor.

Moreover, as described above in connection with FIG. 2B, each rotor gearbox 220 is further coupled to a center gearbox 208 (shown in FIG. 2B) via an interconnect drive shaft link 209, which allows engine/motor power to be shared among all rotor gearboxes, and thus provides redundancy in the event of failure of an engine 215 or motor 217. Thus, given that interconnect drive shaft link 209 couples gearbox 220 to a center gearbox, interconnect drive shaft link 209 interfaces with mast 214 of gearbox 220 at a right angle. Accordingly, gearbox 220 includes a bevel gear set 222 that is used to adapt the rotational direction of interconnect drive shaft link 209 to that of mast 214.

Gearbox 220 further includes an engine clutch 216 and a motor clutch 218 to engage and disengage power transmission from diesel engine 215 and electric motor 217, respectively. In some embodiments, for example, engine clutch 216 and/or motor clutch 218 may be sprag clutches. In this manner, clutches 216 and 218 can be used to selectively enable and disable power from diesel engine 215 and/or electric motor 217. For example, as described above in connection with FIG. 2A, some embodiments of a tailsitter aircraft may only use electric motor 217 to augment the power of diesel engine 215 during hover for takeoff and landing. Accordingly, during takeoff, motor clutch 218 may be engaged in order to enable power transmission from electric motor 217. Once the tailsitter aircraft transitions from takeoff to forward flight, however, motor clutch 218 may then be disengaged in order to disable power transmission from electric motor 217, and electric motor 217 may then be used as a generator to recharge its associated batteries 207 (shown in FIG. 2A). In this manner, when the tailsitter aircraft transitions from forward flight to landing, the batteries 207 (shown in FIG. 2A) will be charged and can be used to power electric motor 217 during landing, and thus motor clutch 218 may be re-engaged to enable power transmission from electric motor 217.

Engine clutch 216 and/or motor clutch 218 may be used to similarly enable/disable power from engine 215 or motor 217 for other purposes. For example, additional power could be provided during forward flight by engaging motor clutch 218 in addition to engine clutch 216, thus enabling power transmission from both diesel engine 215 and electric motor 217 during forward flight. As another example, a stealth mode could be implemented by disengaging power from one or both of engine 215 and motor 217 using clutches 216 and 218, thus reducing the acoustics and/or heat signature of the aircraft. For example, power from electric motor 217 could be enabled using motor clutch 218, while disabling power from diesel engine 215 using engine clutch 216, thus allowing the aircraft to loiter or cruise using only electrical power from motor 217. Disabling power from one or both of engine 215 and motor 217 could similarly be used to reduce heat in order to cool components of the aircraft, such as the exhaust. Moreover, in some embodiments, the batteries 207 (shown in FIG. 2A) of electric motor 217 could be selectively charged at opportune times. For example, during a period of forward flight or cruise when additional power from electric motor 217 is not needed, motor clutch 218 could be disengaged to disable power transmission from electric motor 217, and electric motor 217 could then be used as a generator to recharge the batteries 207 (shown in FIG. 2A).

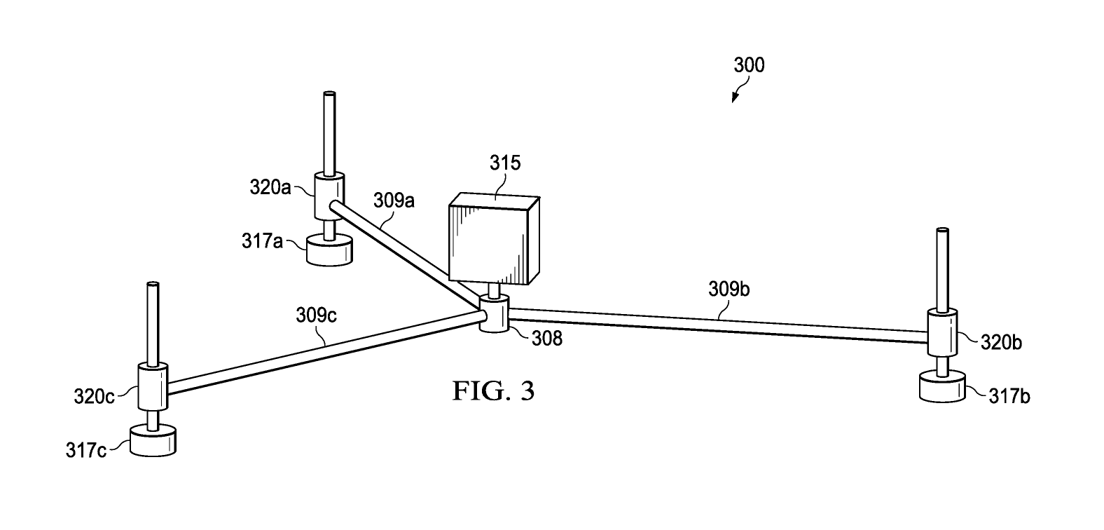

FIG. 3 illustrates an alternative embodiment of a rotor drive system 300 for a tri-rotor tailsitter aircraft. In some embodiments, for example, rotor drive system 300 could be used as an alternative to the rotor drive system illustrated in FIG. 2B.

In the illustrated embodiment, for example, rotor drive system 300 includes a single diesel engine 315 that is shared by the rotors, rather than separate diesel engines for each rotor as in the rotor drive system of FIG. 2B. Rotor drive system 300 may otherwise be similar to the rotor drive system of FIG. 2B. For example, for each of the three supported rotors, rotor drive system 300 includes an associated electric motor 317a-c and rotor gearbox 320a-c. Moreover, each rotor gearbox 320a-c is further coupled to a center gearbox 308 via an interconnect drive shaft link 309a-c, which allows the rotors to share power from the center diesel engine 315 and from their respective electric motors 317a-c. Finally, although the illustrated embodiment includes separate electric motors 317a-c for each rotor, other embodiments may include a single electric motor that is shared among the rotors (e.g., similar to shared diesel engine 315).

By way of comparison to the rotor drive system of FIG. 2B, the use of a single diesel engine 315 in rotor drive system 300 may improve fuel efficiency (e.g., thrust-specific fuel consumption) and mission range, while providing less redundancy in the event of engine failure.

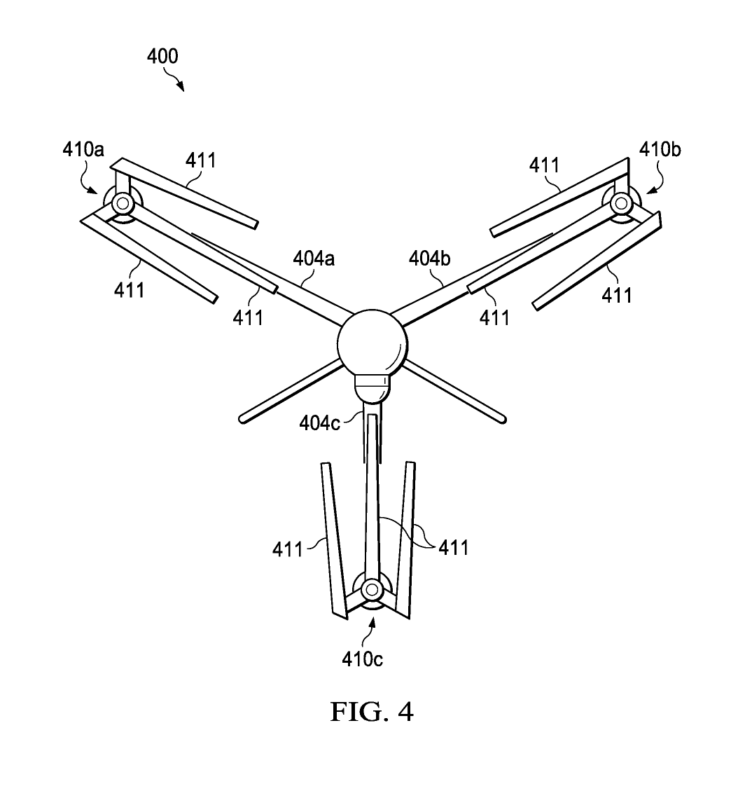

FIG. 4 illustrates an example embodiment of a tri-rotor tailsitter aircraft 400 with foldable wings and blades. In some embodiments, for example, aircraft 400 may be similar to tri-rotor tailsitter rotorcraft 100 of FIGS. 1A-D, but with foldable wings and rotor blades for storage purposes.

In the illustrated embodiment, for example, aircraft 400 is illustrated in its folded configuration. For example, the wing extensions 406a,b of the main wings 404a,b are folded inwards, and the blades 411 of all three rotors 410a-c are similarly folded inwards. In other embodiments, however, aircraft 400 may include other foldable components and/or may include components that are foldable in a variety of locations. Moreover, in various embodiments, aircraft 400 may be implemented with manual and/or automatic folding mechanism(s) in order to facilitate folding and unfolding of the respective foldable components.

In this manner, aircraft 400 can be placed in its foldable configuration to significantly reduce its overall dimensions, thus facilitating storage of aircraft 400 in a hangar or on an aircraft carrier, among other examples.

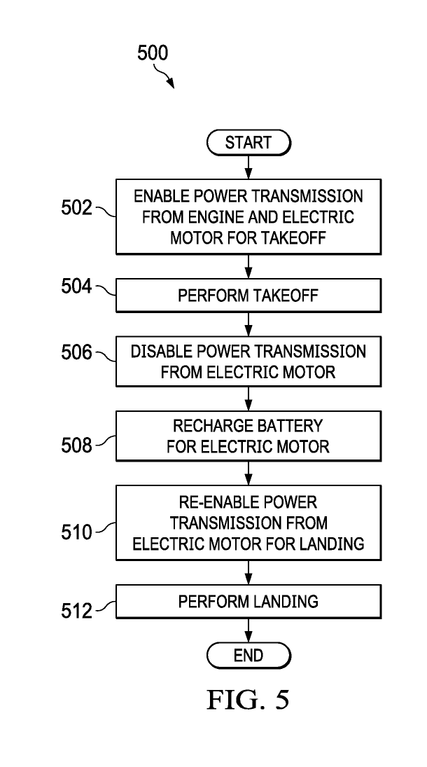

FIG. 5 illustrates a flowchart 500 for an example operation of a tailsitter aircraft. Flowchart 500 may be implemented, for example, using the tailsitter aircraft embodiments described throughout this disclosure, either alone or in conjunction with other aircraft components and systems (e.g., flight controls, flight control systems, and so forth).

The flowchart may begin at block 502 by enabling the power transmission from one or more engines and one or more electric motors in order to power the rotors of the tailsitter aircraft for takeoff. In some embodiments, for example, a tailsitter aircraft may include both fuel-based engine(s) and electric motor(s). The engines may be designed to provide the minimum amount of power needed for forward flight or cruise, while the electric motors may be designed to provide the additional power needed to hover during takeoff and landing, thus minimizing engine and fuel weight. Accordingly, for takeoff, power transmission may be enabled from both the engines and electric motors.

The flowchart may then proceed to block 504 to perform takeoff. In some embodiments, for example, takeoff may be performed by the tailsitter aircraft by ascending in hover mode and transitioning from hover mode to cruise mode (forward flight).

The flowchart may then proceed to block 506 to disable the power transmission from the electric motors. For example, after takeoff is complete, the power from the engines is sufficient for forward flight or cruise, and thus the additional power from the electric motors is no longer needed. Accordingly, the power transmission from the electric motors may be disabled during forward flight or cruise.

The flowchart may then proceed to block 508 to recharge the batteries associated with the electric motors. In some embodiments, for example, given that power from the electric motors may not be needed during forward flight or cruise, the electric motors may instead serve as generators used to recharge their associated batteries. In this manner, when power from the electric motors is subsequently needed for landing, the batteries used to power the electric motors will be re-charged.

The flowchart may then proceed to block 510 to re-enable power transmission from the electric motors for landing. As noted above, the electric motors may be used to augment the power from the engines during takeoff and landing. Accordingly, when the tailsitter aircraft is ready to land, the power transmission from the electric motors may be re-enabled.

The flowchart may then proceed to block 512 to perform landing. In some embodiments, for example, landing may be performed by the tailsitter aircraft by transitioning from cruise mode (forward flight) to hover mode, and descending in hover mode.

At this point, the flowchart may be complete. In some embodiments, however, the flowchart may restart and/or certain blocks may be repeated.

The flowcharts and diagrams in the FIGURES illustrate the architecture, functionality, and operation of possible implementations of various embodiments of the present disclosure. It should also be noted that, in some alternative implementations, the function(s) associated with a particular block may occur out of the order specified in the FIGURES. For example, two blocks shown in succession may, in fact, be executed substantially concurrently, or the blocks may sometimes be executed in the reverse order or alternative orders, depending upon the functionality involved.

Although several embodiments have been illustrated and described in detail, numerous other changes, substitutions, variations, alterations, and/or modifications are possible without departing from the spirit and scope of the present invention, as defined by the appended claims. The particular embodiments described herein are illustrative only, and may be modified and practiced in different but equivalent manners, as would be apparent to those of ordinary skill in the art having the benefit of the teachings herein. Those of ordinary skill in the art would appreciate that the present disclosure may be readily used as a basis for designing or modifying other embodiments for carrying out the same purposes and/or achieving the same advantages of the embodiments introduced herein. For example, certain embodiments may be implemented using more, less, and/or other components than those described herein. Moreover, in certain embodiments, some components may be implemented separately, consolidated into one or more integrated components, and/or omitted. Similarly, methods associated with certain embodiments may be implemented using more, less, and/or other steps than those described herein, and their steps may be performed in any suitable order.

Numerous other changes, substitutions, variations, alterations, and modifications may be ascertained to one of ordinary skill in the art and it is intended that the present disclosure encompass all such changes, substitutions, variations, alterations, and modifications as falling within the scope of the appended claims.

In order to assist the United States Patent and Trademark Office (USPTO), and any readers of any patent issued on this application, in interpreting the claims appended hereto, it is noted that: (a) Applicant does not intend any of the appended claims to invoke paragraph (f) of 35 U.S.C. § 112, as it exists on the date of the filing hereof, unless the words “means for” or “steps for” are explicitly used in the particular claims; and (b) Applicant does not intend, by any statement in the specification, to limit this disclosure in any way that is not otherwise expressly reflected in the appended claims.

What is claimed is:

1. A tailsitter aircraft, comprising:
a fuselage;
a plurality of wings extending radially from the fuselage;
a plurality of rotors coupled to the plurality of wings, wherein each rotor of the plurality of rotors is coupled to a particular wing of the plurality of wings, and wherein the plurality of rotors consists of three rotors; and
at least one engine to power the plurality of rotors.

2. The tailsitter aircraft of claim 1, wherein the at least one engine comprises a plurality of engines, wherein each engine of the plurality of engines is configured to power a particular rotor of the plurality of rotors.

3. The tailsitter aircraft of claim 1, further comprising:
at least one electric motor to power the plurality of rotors; and
at least one battery to power the at least one electric motor.

4. The tailsitter aircraft of claim 3, wherein the at least one electric motor comprises a plurality of electric motors, wherein each electric motor of the plurality of electric motors is configured to power a particular rotor of the plurality of rotors.

5. The tailsitter aircraft of claim 3, wherein the at least one electric motor is configured to augment power from the at least one engine when the tailsitter aircraft is in a hover mode.

6. The tailsitter aircraft of claim 5, wherein the at least one electric motor is further configured to recharge the at least one battery when the tailsitter aircraft is in a cruise mode.

7. The tailsitter aircraft of claim 3, further comprising an interconnect drive shaft configured to share power among the plurality of rotors, wherein the shared power is from the at least one engine or the at least one electric motor.

8. The tailsitter aircraft of claim 1, further comprising one or more wing extensions coupled to one or more wings of the plurality of wings, wherein each wing extension is positioned outboard of a particular rotor of the plurality of rotors.

9. The tailsitter aircraft of claim 1, further comprising one or more foldable components.

10. The tailsitter aircraft of claim 9, wherein the one or more foldable components comprise:
one or more wings of the plurality of wings; or
one or more rotor blades associated with the plurality of rotors.

11. The tailsitter aircraft of claim 1, further comprising:
a plurality of nacelles coupled to the plurality of wings, wherein the plurality of nacelles houses the plurality of rotors; and
landing gear coupled to the plurality of nacelles.

12. The tailsitter aircraft of claim 1, further comprising one or more canards coupled to the fuselage, wherein the one or more canards are positioned on the fuselage forward of the plurality of wings.

13. The tailsitter aircraft of claim 1, wherein the tailsitter aircraft comprises an unmanned aerial vehicle.

14. A tailsitter aircraft, comprising:
a fuselage;
a plurality of wings extending radially from the fuselage;
a plurality of rotors coupled to the plurality of wings, wherein each rotor of the plurality of rotors is coupled to a particular wing of the plurality of wings; and
a propulsion system to power the plurality of rotors, wherein the propulsion system comprises:
at least one engine; and
at least one electric motor powered by at least one battery.

15. The tailsitter aircraft of claim 14, wherein the at least one electric motor is configured to augment power from the at least one engine when the tailsitter aircraft is in a hover mode.

16. The tailsitter aircraft of claim 15, wherein the at least one electric motor is further configured to recharge the at least one battery when the tailsitter aircraft is in a cruise mode.

17. The tailsitter aircraft of claim 14, wherein the propulsion system further comprises an interconnect drive shaft configured to share power among the plurality of rotors, wherein the shared power is from the at least one engine or the at least one electric motor.

18. A method of operating a tailsitter aircraft, comprising:
enabling a power transmission from at least one engine and at least one electric motor for performing a takeoff maneuver for the tailsitter aircraft, wherein the power transmission is configured to power a plurality of rotors associated with the tailsitter aircraft;
performing the takeoff maneuver using the power transmission from the at least one engine and the at least one electric motor;
disabling the power transmission from the at least one electric motor after performing the takeoff maneuver;
recharging a battery associated with the at least one electric motor after performing the takeoff maneuver;
enabling the power transmission from the at least one electric motor for performing a landing maneuver for the tailsitter aircraft; and
performing the landing maneuver using the power transmission from the at least one engine and the at least one electric motor.

19. The method of claim 18, wherein performing the takeoff maneuver comprises causing the tailsitter aircraft to ascend in a hover mode and transition from the hover mode to a cruise mode.

20. The method of claim 19, wherein performing the landing maneuver comprises causing the tailsitter aircraft to transition from the cruise mode to the hover mode and descend in the hover mode.
